(19) United States
(12) Patent Application Publication
(10) Pub. No.: US 2012/0279650 A1
(43) Pub. Date: Nov. 8, 2012

(54) Insulated Beverage Container

(76) Inventors: Vladislav Babinsky, Midlothian, VA (US); Sven Samuel Arenander, Richmond, VA (US); Dobridge Celeste Newman, Glen Allen, VA (US)

(21) Appl. No.: 13/553,126

(22) Filed: Jul. 19, 2012

Related U.S. Application Data
(63) Continuation of application No. 12/910,951, filed on Oct. 25, 2010.
Application No. 12/910,951 is a continuation of application No. 13/327,848, filed on Dec. 16, 2011.

(51) Int. Cl. B32B 37/12

(52) U.S. Cl. 156/293

(57) ABSTRACT

A container including a wall that defines an internal volume and an opening into the internal volume, the wall including an internal surface and an external surface, and being formed as a layered structure that includes a first layer positioned proximate the internal surface and a second layer positioned proximate the external surface, the second layer including major bosses extending into engagement with the first layer to space the second layer from the first layer.

### PRIORITY

This application is a continuation of U.S. Ser. No. 12/910,951 filed on Oct. 25, 2010, the entire contents of which are incorporated herein by reference, and U.S. Ser. No. 13/327,848 filed on Dec. 16, 2011, the entire contents of which are incorporated herein by reference.

### FIELD

This application relates to containers and, more particularly, to insulated beverage containers.

### BACKGROUND

Beverage containers, such as beverage cups, are used to hold both hot and cold beverages. Cold beverages, such as soda and iced tea, are typically served with ice and, over time, result in the formation of water droplets (i.e., condensation) on the external surface of the beverage container due to humidity in the ambient air.

Condensation on the external surface of a beverage container inhibits the user's ability to securely grip the beverage container, which may result in accidental spillage, particularly when the beverage is being consumed on the go. Furthermore, the formation of condensation on the external surface of beverage containers often results in the undesirable pooling of condensate on the surface supporting the beverage container.

Condensate formation may be inhibited by insulating the cold beverage in the beverage container from the external-most surface of the beverage container (i.e., the surface that is in contact with the humid ambient air). As one example, vacuum bottle-type beverage containers use the insulating properties of a vacuum to insulate the external-most surface of the beverage container from the contents of the beverage container, thereby inhibiting, if not eliminating, condensate formation. Unfortunately, vacuum bottle-type beverage containers can be quite expensive and, therefore, are not practical for disposable applications. As another example, polystyrene foam beverage containers are available at a relatively low cost and offer improved insulation and, hence, reduced condensate formation. However, polystyrene foam beverage containers tend to be fragile and are not biodegradable.

Accordingly, those skilled in the art continue with research and development efforts in the field of insulated beverage containers.

### SUMMARY

In one aspect, the disclosed insulated beverage container may include a wall that defines an internal volume and an opening into the internal volume. The wall includes an internal surface and an external surface, and is formed as a layered structure that includes a first layer positioned proximate the internal surface and a second layer positioned proximate the external surface. The second layer includes major bosses extending into engagement with the first layer to space the second layer from the first layer.

In another aspect, the disclosed insulated beverage container may include a wall that defines an internal volume and includes an internal surface and an external surface. The wall is formed as a layered structure that includes a first layer positioned proximate the internal surface and a second layer positioned proximate the external surface. The second layer includes a plurality of major bosses extending into engagement with the first layer to space the second layer from the first layer and a plurality of minor bosses extending away from the first layer. An adhesive connects the second layer to the first layer.

In yet another aspect, the disclosed insulated beverage container may include a side wall that defines a longitudinal axis and an internal volume, a sleeve defining a plurality of major bosses and a plurality of minor bosses, the major bosses having a larger surface area than the minor bosses, wherein the major bosses protrude radially inward into engagement with the side wall to space the sleeve from the side wall, and an adhesive positioned between the sleeve and the side wall.

Other aspects of the disclosed insulated beverage container will become apparent from the following description, the accompanying drawings and the appended claims.

### BRIEF DESCRIPTION OF THE DRAWINGS

FIG. 1 is a front elevational view of one aspect of the disclosed insulated beverage container;

FIG. 2 is a front elevational view, in section, of the insulated beverage container of FIG. 1;

FIG. 3 is a cross-sectional view of a portion of the side wall of the insulated beverage container of FIG. 2;

FIG. 4A is a front elevational view of the insulated beverage container of FIG. 2, shown with the outer layer of the side wall removed to show the underlying structure;

FIG. 4B is a front elevational view of the insulated beverage container of FIG. 4B in accordance with an alternative construction; and

FIG. 5 is a cross-sectional view of a portion of the side wall of an insulated beverage container in accordance with another aspect of the disclosure.

### DETAILED DESCRIPTION

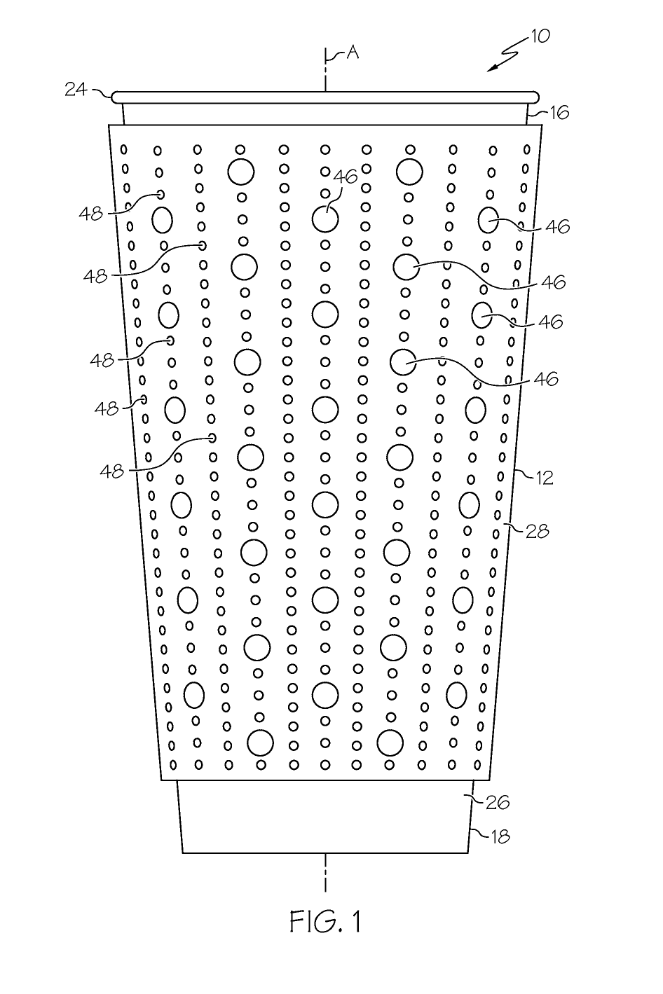

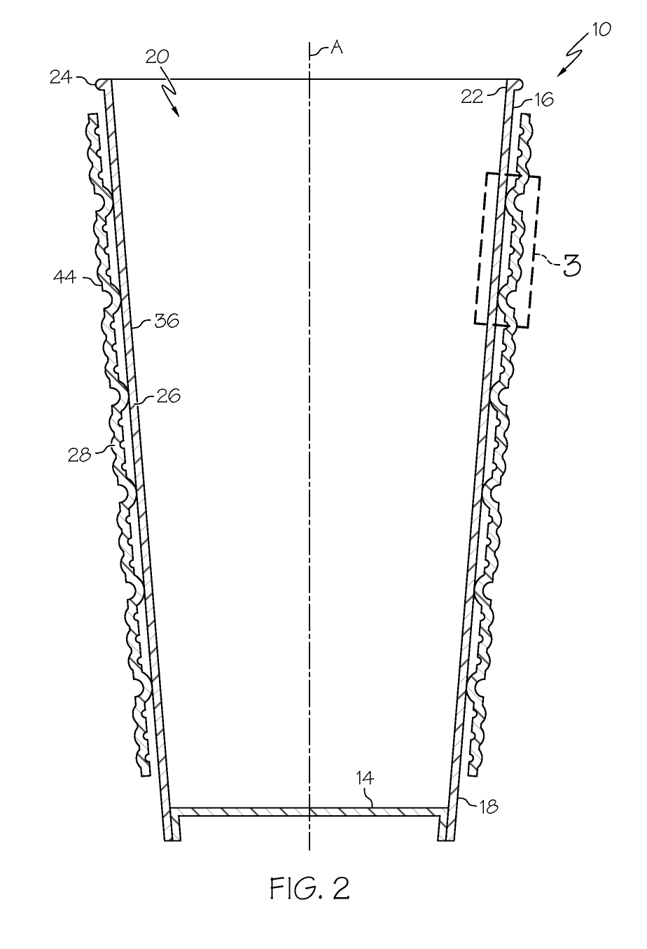

Referring to FIGS. 1 and 2, one aspect of the disclosed insulated beverage container, generally designated 10, may be formed as a beverage cup, such as a 12-ounce, 16-ounce, 21-ounce or 24-ounce disposable take-out beverage cup. While a generally frustoconical beverage container is shown in FIGS. 1 and 2, those skilled in the art will appreciate that beverage containers of various shapes and sizes may be constructed without departing from the scope of the present disclosure.

The insulated beverage container 10 may include a side wall 12 and a bottom wall 14 (FIG. 2). The side wall 12 may include an upper end portion 16 and a lower end portion 18, and may extend circumferentially about a longitudinal axis A to define an internal volume 20 (FIG. 2) of the insulated beverage container 10. The bottom wall 14 may be connected to the lower end portion 18 of the side wall 12 to partially enclose the internal volume 20. The upper end portion 16 of the side wall 12 may define an opening 22 (FIG. 2) into the internal volume 20. Optionally, the upper end portion 16 of the side wall 12 may additionally include a circumferential lip 24 for securing a lid (not shown) or the like to the upper end portion 16 of the side wall 12, thereby further enclosing the internal volume 20.

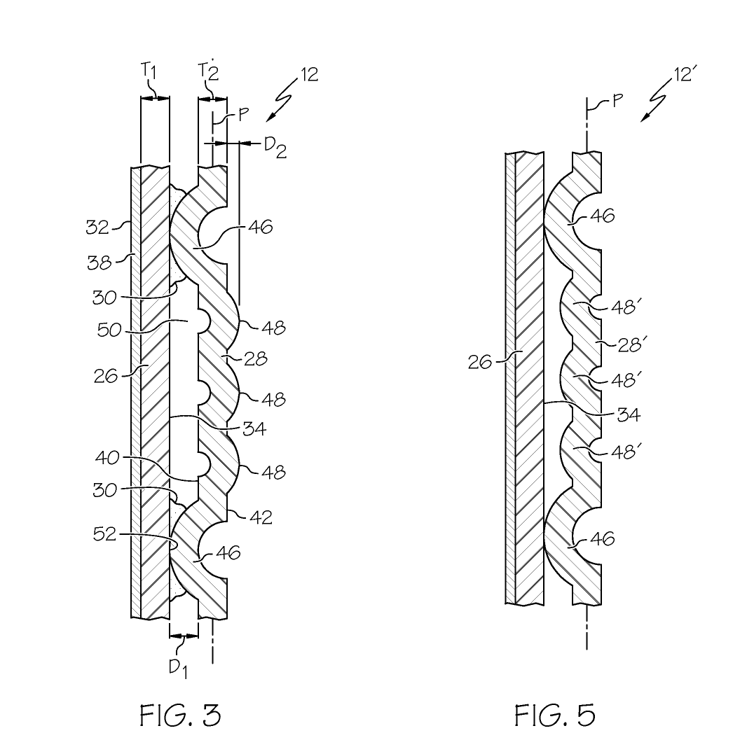

As shown in FIG. 3, the side wall 12 may be formed as a layered structure that includes a first, inner layer 26 and a second, outer layer 28. The outer layer 28 may be spaced apart from the inner layer 26, as will be described in greater detail below. An adhesive 30 may connect the outer layer 28 to the inner layer 26.

The inner layer 26 may include an inner surface 32 and an outer surface 34. The inner surface 32 of the inner layer 26 may define (or may be proximate) the interior surface 36 (FIG. 2) of the side wall 12.

In one optional implementation, the inner surface 32 of the inner layer 26 may be coated with a moisture barrier layer 38, thereby rendering the interior surface 36 of the side wall 12 of the insulated beverage container 10 resistant to moisture penetration when the internal volume 20 of the insulated beverage container 10 is filled with a beverage (not shown). The moisture barrier layer 38 may have a cross-sectional thickness ranging from about 0.5 to about 3.5 points, wherein 1 point equals 0.001 inches. For example, the moisture barrier layer 38 may be (or may include) a layer of polyethylene that has been laminated, extrusion coated or otherwise connected (e.g., with adhesives) to the inner surface 32 of the inner layer 26. Other moisture barrier materials useful in the moisture barrier layer 44 are commercially available and known to the skilled artisan.

The inner layer 26 may be formed from a sheet of material capable of being shaped into the side wall 12. The inner layer 26 may have a cross-sectional thickness T₁ and a rigidity sufficient to impart the side wall 12 of the insulated beverage container 10 with sufficient structural integrity to maintain the desired shape of the insulated beverage container 10 when a beverage is placed in the internal volume 20. In one construction, the inner layer 26 may be formed from a recyclable material, such as paperboard. The paperboard may have a cross-sectional thickness T₁ of at least about 6 points, such as about 8 to about 24 points. In another construction, the inner layer 26 may be formed from a polymeric material, such as polycarbonate or polyethylene terephthalate.

The outer layer 28 may include an inner surface 40 and an outer surface 42. The outer surface 42 of the outer layer 28 may define (or may be proximate) the external surface 44 (FIG. 2) of the side wall 12.

The outer layer 28 may be a sleeve or wrap positioned over the inner layer 26. As such, the overall surface area of the outer layer 28 may be less than the overall surface area of the inner layer 26, as shown in FIGS. 1 and 2. Therefore, the outer layer 28 may cover only a portion of the inner layer 26. As one example, the outer layer 28 may cover at least 60 percent of the inner layer 26. As another example, the outer layer 28 may cover at least 80 percent of the inner layer 26. As yet another example, the outer layer 28 may cover at least 90 percent of the inner layer 26.

The outer layer 28 may be formed from a sheet of paperboard, which may be bleached or unbleached, and which may have a basis weight of at least about 85 pounds per 3000 square feet and a thickness T₂ of at least about 6 points. For example, the outer layer 28 may be formed from paperboard, such as linerboard or solid bleached sulfate (SBS), having a basis weight ranging from about 180 to about 270 pounds per 3000 square feet and a thickness T₂ ranging from about 8 to 36 points.

As shown in FIGS. 1-3, the outer layer 28 may include a plurality of major bosses 46 and a plurality of minor bosses 48. In one particular implementation, the major and minor bosses 46, 48 may be formed by embossing the outer layer 28 prior to forming the side wall 12. For example, a sheet of paperboard may be passed through an embossing press prior to forming the outer layer 28 of the side wall 12.

The major bosses 46 may have a surface area (in plan view) ranging from about 25 to about 100 mm². For example, the major bosses 46 shown in FIG. 1 are hemispherical (circular in plan view) and may have a diameter of about 8 mm. Therefore, the major bosses 46 shown in FIG. 1 may have a surface area of about 50 mm². While the major bosses 46 are shown as being circular (in plan view) in the drawings, those skilled in the art will appreciate that major bosses 46 of various shapes (in plan view), such as diamond, square, oblong, star or irregular, may be used without departing from the scope of the present disclosure.

The major bosses 46 may be spaced across the outer layer 28 of the side wall 12. In one particular expression, the center of each major boss 46 may be spaced about 15 to 50 mm from the center of each adjacent major boss 46. As a first example, the major bosses 46 may be equidistantly spaced across the outer layer 28 of the side wall 12. As a second example, the major bosses 46 may be arranged in a uniform pattern across the outer layer 28 of the side wall 12. As a third example, the major bosses 46 may be randomly arranged across the outer layer 28 of the side wall 12.

In one embodiment, the total surface area of the major bosses 46 (i.e., the total number of major bosses on the outer layer 28 multiplied by the average surface area of the major bosses) may account for about 2 to about 20 percent of the total surface area of the outer layer 28 of the side wall 12. As a specific example, the major bosses 46 may account for about 8 percent of the total surface area of the outer layer 28 of the side wall 12.

In another embodiment, the outer layer 28 of the side wall 12 may include about 0.5 to about 2 major bosses 46 per square inch of the outer layer 28. As a specific example, the outer layer 28 of the side wall 12 may include about 1.25 major bosses 46 per square inch of the outer layer 28.

At this point, those skilled in the art will appreciate that the number of major bosses 46 present on the outer layer 28 of the side wall 12 may be dictated by the overall surface area of the outer layer 28.

Referring to FIG. 3, the major bosses 46 may protrude radially inward from the plane P (a wrapped plane) defined by the outer layer 28 of the side wall 12 (i.e., toward the inner layer 26) such that each major boss 46 has a depth D₁ and extends into engagement with the inner layer 26. In one general example, the depth D₁ of each major boss 46 may be at least 5 points. In another general example, the depth D₁ of each major boss 46 may range from about 10 to about 25 points.

Thus, the major bosses 46 may function as spacers that space the outer layer 28 from the inner layer 26 by a distance corresponding to the depth D₁ of the major bosses 46. As such, an annular region 50 may be defined between the inner and outer layers 26, 28.

As best shown in FIG. 3, the valley 52 (i.e., the distal end) of each major boss 46 may be rounded (or pointed) to minimize contact between the inner layer 26 and the outer layer 28. The rounded valley 52 of each major boss 46 may have a radius of at most 20 mm. Those skilled in the art will appreciate that minimizing the total surface area of the outer layer 28 that is in contact with the inner layer 26 may inhibit heat transfer between the inner layer 26 and the outer layer 28.

The minor bosses 48 may have a surface area that is less than the surface area of the major bosses 46. In one realization, the minor bosses 48 may have a surface area (in plan view) ranging from about 1 to about 25 mm². For example, the minor bosses 48 shown in FIG. 1 are hemispherical (circular in plan view) and may have a diameter of about 3 mm. Therefore, the minor bosses 48 shown in FIG. 1 may have a surface area of about 7 mm². In another realization, the minor bosses 48 may have a surface area (in plan view) that is at most 25 percent of the surface area of the major bosses 46. While the minor bosses 48 are shown as being circular (in plan view) in the drawings, those skilled in the art will appreciate that minor bosses 48 of various shapes (in plan view), such as diamond, square, oblong, star or irregular, may be used without departing from the scope of the present disclosure.

The minor bosses 48 may be spaced across the outer layer 28 of the side wall 12. In one particular expression, the center of each minor boss 48 may be spaced about 1 to 15 mm from the center of each adjacent minor boss 48. As a first example, the minor bosses 48 may be equidistantly spaced across the outer layer 28 of the side wall 12. As a second example, the minor bosses 48 may be arranged in a uniform pattern across the outer layer 28 of the side wall 12. As a third example, the minor bosses 48 may be randomly arranged across the outer layer 28 of the side wall 12.

In one embodiment, the number of minor bosses 48 present on the outer layer 28 of the side wall 12 may be dictated by the number of major bosses 46 present. As one general example, the outer layer 28 of the side wall 12 may include at least 4 minor bosses 48 for each major boss 46. As another general example, the outer layer 28 of the side wall 12 may include about 6 to about 20 minor bosses 48 for each major boss 46. As a specific example, the outer layer 28 of the side wall 12 may include 12 minor bosses 48 for each major boss 46.

In another embodiment, the number of minor bosses 48 present on the outer layer 28 of the side wall 12 may be dictated by the overall surface area of the outer layer 28 of the side wall 12. As one general example, the outer layer 28 of the side wall 12 may include at least 10 minor bosses 48 per square inch of the outer layer 28. As another general example, the outer layer 28 of the side wall 12 may include about 15 to about 25 minor bosses 48 per square inch of the outer layer 28. As a specific example, the outer layer 28 of the side wall 12 may include 20 minor bosses 48 per square inch of the outer layer 28.

As shown in FIG. 3, the minor bosses 48 may protrude radially outward from the plane P defined by the outer layer 28 of the side wall 12 (i.e., away from the inner layer 26) and may have a protruding depth D₂. The protruding depth D₂ of each minor boss 48 may be less than the protruding depth D₁ of the major bosses 46. In one general example, the depth D₂ of each minor boss 48 may be at least 2 points. In another general example, the depth D₂ of each minor boss 48 may range from about 4 to about 10 points.

Thus, the minor bosses 48 may further space the outer layer 28 from the inner layer 26, thereby further increasing the volume of the annular region 50 between the inner and outer layers 26, 28. Furthermore, the minor bosses 48 may texture the external surface 44 of the side wall 12 to enhance the ability to grip the insulated beverage container 10.

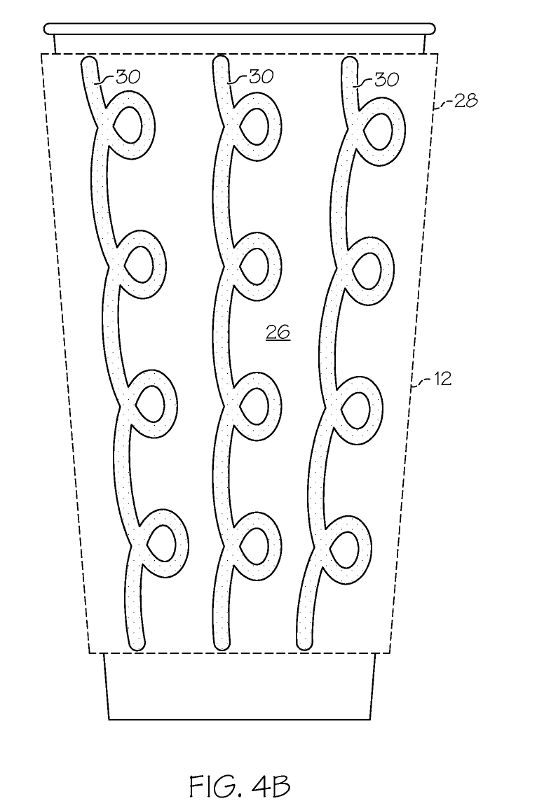

As shown in FIG. 5, in an alternative aspect, the minor bosses 48′ may protrude radially inward from the plane P defined by the outer layer 28′ of the side wall 12′ (i.e., toward the inner layer 26). Such inwardly protruding minor bosses 48′ may also provide the external surface 44 of the side wall 12 with sufficient texture to enhance the ability to grip the insulated beverage container 10.

Optionally, the paperboard used to form the outer layer 28 may include various components and optional additives in addition to cellulosic fibers. For example, the outer layer 28 may optionally include one or more of the following: binders, fillers, organic pigments, inorganic pigments, hollow plastic pigments, expandable microspheres and bulking agents, such as chemical bulking agents.

In a first optional aspect, the paperboard used to form the outer layer 28 may include ground wood particles dispersed therein. Without being limited to any particular theory, it is believed that the presence of ground wood particles in the outer layer 28 may encourage the absorption of condensation that is formed on the external surface 44 of the side wall 12 into the outer layer 28.

In a second optional aspect, the outer layer 28 may be engineered to maximize the transfer of moisture (i.e., condensation) forming on the external surface 44 of the side wall 12 into the outer layer 28. For example, the surface sizing and the porosity of both the inner and outer surfaces 40, 42 of the outer layer 28 may be engineered to maximize moisture (i.e., condensation) absorption and minimize the negative effects of condensate formation.

In one implementation of the second optional aspect, the surface sizing of the inner and outer surfaces 40, 42 of the outer layer 28 may be controlled such that the inner surface 40 has a Hercules sizing that is less than the Hercules sizing of the outer surface 42. For example, the surface sizing of the inner and outer surfaces 40, 42 of the outer layer 28 may be controlled such that the inner surface 40 has a sizing in the range from about 30 to about 80 Hercules units, while the outer surface 42 has a sizing in the range from about 100 to about 150 Hercules units.

In another implementation of the second optional aspect, the porosities of the inner and outer surfaces 40, 42 of the outer layer 28 may be controlled such that the inner surface 40 has a Gurley porosity that is less than the Gurley porosity of the outer surface 42 (i.e., greater pore volume on the inner surface 40 than on the outer surface 42). For example, the porosities of the inner and outer surfaces 40, 42 of the outer layer 28 may be controlled such that the inner surface 40 has a porosity of about 20 Gurley units (400 cc test), while the outer surface 42 has a porosity of about 40 Gurley units (400 cc test).

Those skilled in the art will appreciate that surface sizing may be controlled using various sizing agents, such as alkyl ketene dimer. Furthermore, those skilled in the art will appreciate that other properties pertaining to moisture absorption, such as porosity, can be achieved by modifying the paperboard making process, such as modifying the selection of the forming, pressing and drying fabrics.

Accordingly, by modifying the surface sizing and porosity of both the inner and outer surfaces 40, 42 of the outer layer 28, the rate of moisture absorption can be controlled. For example, moisture absorption rates of 0.02 to 0.1 g/cm²/min at the outer surface 42 and 0.03 to 0.2 g/cm²/min at the inner surface 40 may be achieved.

As noted above, the outer layer 28 of the side wall 12 may be connected to the inner layer 26 with an adhesive 30 (FIG. 3). Other techniques for securing the outer layer 28 relative to the inner layer 26 are also contemplated. For example, mechanical fasteners or an interference fit may provide the necessary connection between the inner and outer layers 26, 28.

Those skilled in the art will appreciate that various adhesives may be used to connect the outer layer 28 to the inner layer 26. However, in one particular implementation, the adhesive 30 may be a thermally insulating adhesive. An adhesive may be deemed thermally insulating if it has an insulating R value per unit of thickness that is greater than the insulating R value per unit of thickness of the outer layer 28. For example, the ratio of the insulating R value per unit of thickness of the adhesive 30 to the insulating R value per unit thickness of the outer layer 28 may be at least about 1.25:1, such as 1.5:1, 2:1 or even 3:1.

A suitable thermally insulating adhesive 30 may be formed as a composite material that includes an organic binder and a filler. The organic binder may comprise 15 to 70 percent by weight of the adhesive 30 and the filler may comprise 2 to 70 percent by weight of the adhesive 30.

The organic binder component of the thermally insulating adhesive 30 may be any material, mixture or dispersion capable of bonding the outer layer 28 to the inner layer 26. The organic binder may also have insulating properties. Examples of suitable organic binders include latexes, such as styrene-butadiene latex and acrylic latex, starch, such as ungelatinized starch, polyvinyl alcohol, polyvinyl acetate, and mixtures and combinations thereof.

The filler component of the thermally insulating adhesive 30 may include an organic filler, an inorganic filler, or a combination of organic and inorganic fillers. Organic fillers include hard organic fillers and soft organic fillers. Examples of suitable hard organic fillers include sawdust and ground wood. Examples of suitable soft organic fillers include cellulose pulp, pearl starch, synthetic fiber (e.g., rayon fiber), gluten feed, corn seed skin and kenaf core (a plant material). Examples of suitable inorganic fillers include calcium carbonate, clay, perlite, ceramic particles, gypsum and plaster. For example, organic filler may comprise 2 to 70 percent by weight of the thermally insulating adhesive 30 and inorganic filler may comprise 0 to 30 percent by weight of the thermally insulating adhesive 30.

All or a portion of the filler may have a relatively high particle size (e.g., 500 microns or more). The use of high particle size filler material may provide the thermally insulating adhesive 30 with structure such that the thermally insulating adhesive 30 functions to further space the outer layer 28 of the side wall 12 from the inner layer 26. For example, the thermally insulating adhesive 30 may be formed as a composite material that includes an organic binder and a hard organic filler, such as sawdust, that has an average particle size of at least 500 microns, such as about 1000 to about 2000 microns.

In one particular expression, the thermally insulating adhesive 30 may be a foam. The foam may be formed by mechanically whipping the components of the thermally insulating adhesive 30 prior to application. Optionally, a foam forming agent may be included in the adhesive layer formulation to promote foam formation. As one example, 10 to 60 percent of the foam of the thermally insulating adhesive 30 may be open voids, thereby facilitating the absorption of moisture from the external surface 44 of the insulated beverage container 10. As another example, 10 to 30 percent of the foam of the thermally insulating adhesive 30 may be open voids.

In another particular expression, the thermally insulating adhesive 30 may be formed from a binder-filler formulation having a pseudoplasticity index in the range of 0.3 to 0.5. Such a pseudoplasticity index may provide the thermally insulating adhesive 30 with a sufficient minimum thickness, while preserving the ability to apply the formulation at a low viscosity. For example, the formulation may have a low shear viscosity in the range of 2,000 to 50,000 centipoises and a high shear viscosity in the range of 100 to 5,000 centipoises.

As one option, the thermally insulating adhesive 30 may additionally include a plasticizer. The plasticizer may comprise 0.5 to 10 percent by weight of the thermally insulating adhesive 30. Examples of suitable plasticizers include sorbitol, Emtal emulsified fatty acids and glycerine.

As another option, the thermally insulating adhesive 30 may additionally include sodium silicate, which may act as a filler, but is believed to aid in binding and curing of the binder by rapidly increasing viscosity of the binder during the drying process. The sodium silicate may comprise 0 to 15 percent by weight of the thermally insulating adhesive 30, such as about 1 to about 5 percent by weight of the thermally insulating adhesive 30.

As yet another option, the thermally insulating adhesive 30 may be formulated to be biodegradable.

As a specific example, the thermally insulating adhesive 30 may include styrene-butadiene or acrylic SRB latex (binder), wood flour (organic filler), AeroWhip® (foam stabilizer available from Ashland Aqualon Functional Ingredients of Wilmington, Del.), corn fibers (organic filler), calcium carbonate (inorganic filler) and starch (binder), wherein the components of the thermally insulating adhesive have been mechanically whipped together to form a foam. Other examples of suitable thermally insulating adhesives are described in greater detail in U.S. Ser. No. 61/287,990 filed on Dec. 18, 2009, the entire contents of which are incorporated herein by reference.

The adhesive 30 may be positioned between the inner and outer layers 26, 28 in various ways to connect the inner layer 26 to the outer layer 28. When the adhesive 30 is a thermally insulating adhesive, such as a foam adhesive, a portion (if not all) of the annual region 50 between the inner and outer layers 26, 28 may be filled with the thermally insulating adhesive.

In one construction, the adhesive 30 may be deposited at the points where the major bosses 46 contact the inner layer 26. Therefore, the adhesive 30 may be concentrated around the major bosses 46 and may only slightly fill the annular region 50.

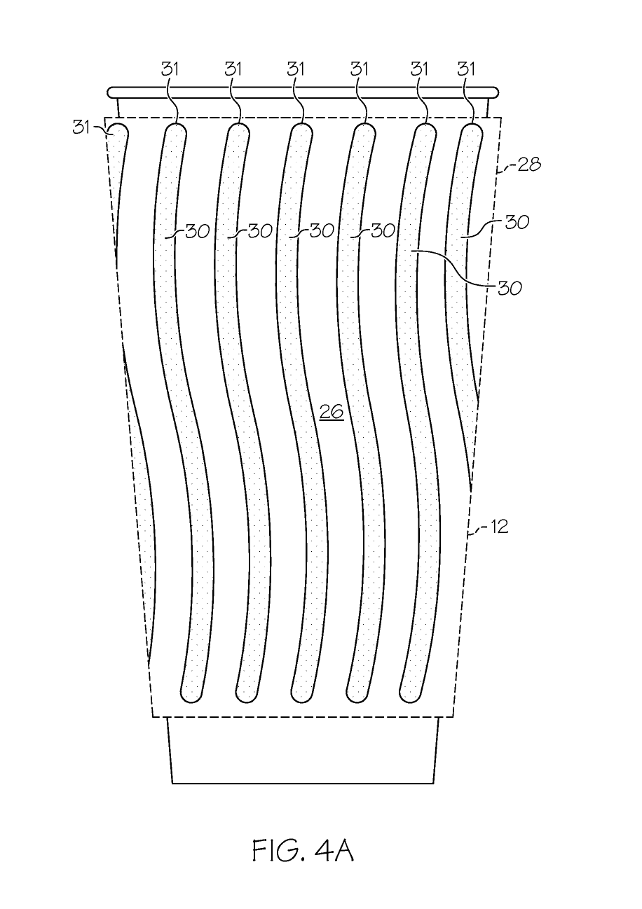

In another construction, the adhesive 30 may be applied to the inner and/or outer layers 26, 28 as a plurality of strings 31, as shown in FIG. 4A. The strings 31 may extend longitudinally (FIG. 4A), laterally (not shown) or otherwise along the side wall 12, and may be applied at a coating thickness that is equal to or greater than the protrusion depth D₁ of the major bosses 46. In the assembled container 10, the strings 31 of adhesive 30 may be sandwiched between the inner and outer layers 26, 28 and may fill (at least partially) the annular region 50.

In another construction, the adhesive 30 may be applied to the inner and/or outer layers 26, 28 in a swirl pattern, as shown in FIG. 4B. The swirl pattern may extend longitudinally (FIG. 4B), laterally (not shown) or otherwise along the side wall 12. In the assembled container 10, the swirl pattern of adhesive 30 may be sandwiched between the inner and outer layers 26, 28 and may fill (at least partially) the annular region 50.

In yet another construction, the adhesive 30 may cover all, or only a portion, of the inner surface 40 of the outer layer 28. As one example, the adhesive 30 may cover about 20 to about 100 percent of the surface area of the inner surface 40 of the outer layer 28. As another example, the adhesive 30 may cover about 20 to about 80 percent of the surface area of the inner surface 40 of the outer layer 28. As yet another example, the adhesive 30 may cover about 40 to about 60 percent of the surface area of the inner surface 40 of the outer layer 28. As yet another example, the adhesive 30 may cover about 50 percent of the surface area of the inner surface 40 of the outer layer 28.

Accordingly, the disclosed insulated beverage container 10 comprises inwardly-extending major bosses 46 that space the outer layer 28 of the side wall 12 from the inner layer 26, thereby defining an annular region 50 that insulates the outer layer 28 from the inner layer 26. Furthermore, the disclosed insulated beverage container 10 comprises minor bosses 48 that provide surface texture that promotes gripping of the container 10 and, when the minor bosses extend radially outward, increase the volume of the annular region 50 to increase the insulating effect of the annular region 50.

Although various aspects of the disclosed insulated beverage container have been shown and described, modifications may occur to those skilled in the art upon reading the specification. The present application includes such modifications and is limited only by the scope of the claims.

What is claimed is:

1. A method for manufacturing a container comprising the steps of:
providing a first layer and a second layer, wherein said second layer comprises a plurality of major bosses;
applying an adhesive to at least one of said first layer and said second layer, wherein said adhesive has a pseudoplasticity index ranging from 0.3 to 0.5; and
forming a layered structure comprising said first layer, said second layer, and said adhesive positioned between said first layer and said second layer, wherein, in said layered structure, said plurality of major bosses protrude into engagement with said first layer to space said second layer from said first layer.

2. The method of claim 1 wherein said layered structure extends circumferentially about a longitudinal axis to define a side wall having an upper end portion and a lower end portion.

3. The method of claim 2 wherein said plurality of major bosses protrude radially inward.

4. The method of claim 2 further comprising the step of connecting a bottom wall to said lower end portion.

5. The method of claim 1 wherein said adhesive contacts both said first layer and said second layer.

6. The method of claim 1 wherein said adhesive is a foam.

7. The method of claim 1 wherein said adhesive comprises an organic binder and an organic filler.

8. The method of claim 7 wherein said organic filler has an average particle size of at least 500 microns.

9. The method of claim 8 wherein said organic filler comprises at least one of sawdust and ground wood.

10. The method of claim 7 wherein said organic binder comprises at least one of latex and starch.

11. The method of claim 7 wherein said adhesive further comprises a plasticizer.

12. The method of claim 1 wherein said adhesive is positioned between said first layer and said plurality of major bosses.

13. The method of claim 1 further comprising the step of embossing said second layer to form said plurality of major bosses.

14. The method of claim 1 wherein each major boss of said plurality of major bosses has a surface area ranging from about 25 to about 100 mm².

15. The method of claim 1 wherein each major boss of said plurality of major bosses is spaced about 15 to about 50 mm from adjacent major bosses of said plurality of major bosses.

16. The method of claim 1 wherein said second layer has a surface area, and wherein said plurality of major bosses comprises about 2 to about 20 percent of said surface area.

17. The method of claim 1 wherein said second layer comprises about 0.5 to about 2 major bosses of said plurality of major bosses per square inch of said second layer.

18. The method of claim 1 wherein each major boss of said plurality of major bosses has a protruding depth of at least 5 points.

19. The method of claim 1 wherein said second layer further comprises a plurality of minor bosses, each minor boss of said plurality of minor bosses having an average minor boss surface area, each major boss of said plurality of major bosses having an average major boss surface area, said average minor boss surface area being less than said average major boss surface area.

20. The method of claim 19 wherein, in said layered structure, said plurality of minor bosses protrude away from said first layer.
